(19) United States
(12) Patent Application Publication
(10) Pub. No.: US 2006/0277102 A1
(43) Pub. Date: Dec. 7, 2006

(54) System and Method for Generating Effective Advertisements in Electronic Commerce

(75) Inventor: Joe Agliozzo, Manhattan Beach, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Better, Inc.

(21) Appl. No.: 11/422,521

(22) Filed: Jun. 6, 2006

Related U.S. Application Data
(60) Provisional application No. 60/688,020, filed on Jun. 6, 2005.

(51) Int. Cl. G06Q 30/00

(52) U.S. Cl. 705/14

(57) ABSTRACT

An advertising analysis system for providing at least one optimal advertisement from an incoming advertisement having a plurality of modifiable advertisement elements and methods for manufacturing and using same. Analyzing each possible advertisement variation of the advertisement, the advertising analysis system applies multivariate testing to identify the advertisement variations with selected combinations of advertisement elements as being optimal test cases and provides the identified advertisement variations as test advertisements. User response to each test advertisement is compiled as test results during a predetermined test period. Based upon the test results, the advertising analysis system performs multivariate testing to analyze the interrelation among the tested advertisement elements and extrapolates the test results to predict the effectiveness of each advertisement variation. The advertising analysis system thereby automatically provides a predetermined number of the advertisement variations with the optimal predicted effectiveness as the more-effective advertisements in a timely manner.

### CROSS-REFERENCE TO RELATED APPLICATIONS

This application claims priority to a U.S. provisional patent application Ser. No. 60/688,020, filed on Jun. 6, 2005. Priority to the provisional application is expressly claimed, and the disclosure of the provisional application is hereby incorporated by reference in its entirety.

### FIELD

The present invention relates generally to advertising systems and more particularly, but not exclusively, to systems for creating, testing, analyzing, and/or selecting Internet advertising and electronic commerce (or ecommerce) systems.

### BACKGROUND

Modern companies presently use a variety of advertising techniques to attract users to their webpages and continually seek to improve their advertisements to generate higher and more profitable responses.

In current state of the art systems, companies, either manually or through software, test advertising performance on metrics between two advertisements (called “split” or “A/B” testing) or a complete factorial design that requires generation and testing of all possible combinations. The first method produces little valuable information for other possible combinations; while, the second method requires very large numbers of test cases in order to achieve statistical significance. Split testing further is incapable of: (1) testing the inter-relations of tested factors; and (2) being executed in a rapid and time-sensitive fashion. Likewise, by the time a split test trial has been completed, conditions in the Internet advertising world may have changed enough to render the test essentially meaningless.

Companies that employ split-testing methodologies cannot statistically infer the relative performance of any combination of advertisement variables with the exception of the two specific permutations tested. These methodologies limit the ability to extrapolate or generalize other permutations. Current state of the art systems also force companies to use techniques that require large amounts of data which in turn require long testing periods. The disadvantage of requiring large amounts of data is that, by the time testing is completed, conditions within the relevant advertising domain may have changed, reducing the efficacy of test results or making them meaningless. Current methods likewise fail because the experimental setups require a fundamental understanding of experimental design and testing, which most clients do not have, or the interface and design elements are either too complicated or too removed from the client.

In view of the foregoing, a need exists for an improved advertising (or electronic commerce) system that overcomes the aforementioned obstacles and deficiencies of currently-available advertising systems.

### BRIEF DESCRIPTION OF THE DRAWINGS

FIG. 1 is an exemplary top-level block diagram illustrating an embodiment of an advertising system, wherein the advertising system includes an advertisement analysis system for providing at least one effective advertisement from an incoming advertisement.

FIG. 2A is a detail drawing illustrating an embodiment of an exemplary advertisement received by the advertisement analysis system of FIG. 1, wherein the advertisement includes at least one advertisement element.

FIG. 2B is a detail drawing illustrating an embodiment of an exemplary advertisement element of the advertisement of FIG. 2A, wherein the advertisement element can comprise an advertisement element option selected from a plurality of advertisement element options.

FIG. 3A is an exemplary block diagram illustrating an alternative embodiment of the advertising system of FIG. 1, wherein the advertising system further includes an advertising network for compiling user response to test advertisements provided by the advertisement analysis system and for providing the compiled user response as test results to the advertisement analysis system.

FIG. 3B is an exemplary block diagram illustrating another alternative embodiment of the advertising system of FIG. 1, wherein the advertising system communicates with an advertiser system and a user system via a communication network.

FIG. 4A is a detail drawing illustrating an embodiment of the advertising network of FIGS. 3A-B, wherein the advertising network comprises a search engine for performing key word searching via the Internet.

FIG. 4B is a detail drawing illustrating an alternative embodiment of the advertisement of FIG. 2A, wherein the advertisement is adapted for presentation via the search engine of FIG. 4A and comprises a plurality of exemplary advertisement elements.

FIG. 4C is a detail drawing illustrating exemplary advertisement element options for the advertisement of FIG. 4B, wherein at least one advertisement element of the advertisement comprises an advertisement element option selectable from a plurality of advertisement element options.

FIG. 5A is a detail drawing illustrating an embodiment of possible advertisement variations of the exemplary advertisement of FIGS. 4A-C.

FIG. 5B is a detail drawing illustrating an alternative embodiment of the possible advertisement variations of the exemplary advertisement of FIGS. 4A-C, wherein an arrangement of the advertisement elements within the advertisement can be modified.

FIG. 6A is a detail drawing illustrating exemplary test advertisements of the advertisement variations of FIG. 5B, wherein the advertisement analysis system derives the test advertisements from the advertisement variations for testing.

FIG. 6B is an exemplary flow chart illustrating an embodiment of a method by which the advertisement analysis system derives the test advertisements of FIG. 6A from the advertisement variations of FIG. 5B.

FIG. 7A is a detail drawing illustrating exemplary extrapolated advertisement results for the test advertisements of FIGS. 6A-B, wherein the advertising network compiles test results regarding the actual usage of the test advertisements by end users during a predetermined test period, wherein and the advertisement analysis system, based upon the test results, predicts the outcome of testing each of the advertisement variations of FIG. 5B.

FIG. 7B is an exemplary flow chart illustrating an embodiment of a method by which the advertisement analysis system, based upon the test results of FIG. 7A, predicts the outcome of testing each of the advertisement variations of FIG. 5B.

FIG. 8 is a detail drawing illustrating a preselected number of exemplary effective advertisements for the advertisement variations of FIG. 5B, wherein the effective advertisements comprise the advertisement variations with the optimal extrapolated advertisement results of FIGS. 7A-B.

FIG. 9A is a detail drawing illustrating an embodiment of the advertisement analysis system of FIG. 1, wherein the advertisement analysis system includes an interface system and an optimization system.

FIG. 9B is a detail drawing illustrating an embodiment of the optimization system of FIG. 9A.

FIG. 10 is an exemplary top-level flow chart illustrating an embodiment of a typical application flow for the advertisement analysis system of FIG. 1.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present invention. The figures do not describe every aspect of the present invention and do not limit the scope of the invention.

### DETAILED DESCRIPTION OF THE PREFERRED EMBODIMENTS

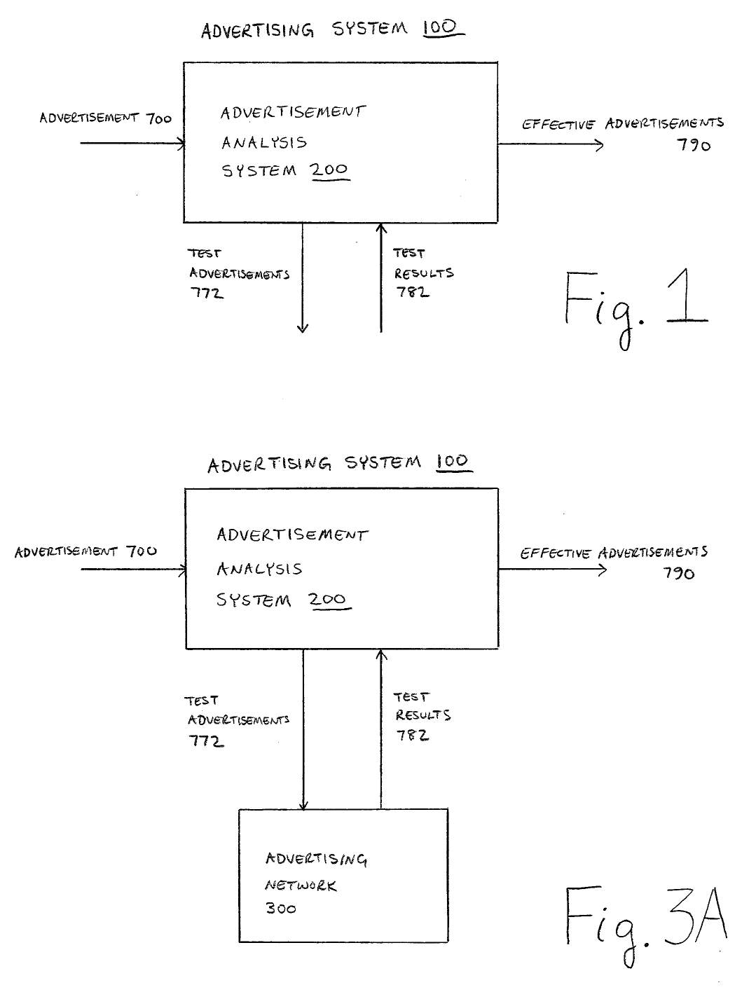

Since currently-available advertising systems require large amounts of data to be acquired over long testing periods and have limited data extrapolation capabilities, an improved advertising system that provides automated advertisement selection for harvesting representative user response data and that applies multivariate and statistical methodologies for analyzing the harvested data can prove desirable and provide a basis for a wide range of advertisement system applications, such as electronic commerce (or ecommerce) systems via the Internet. This result can be achieved, according to one embodiment disclosed herein, by employing an advertising system 100 as shown in FIG. 1.

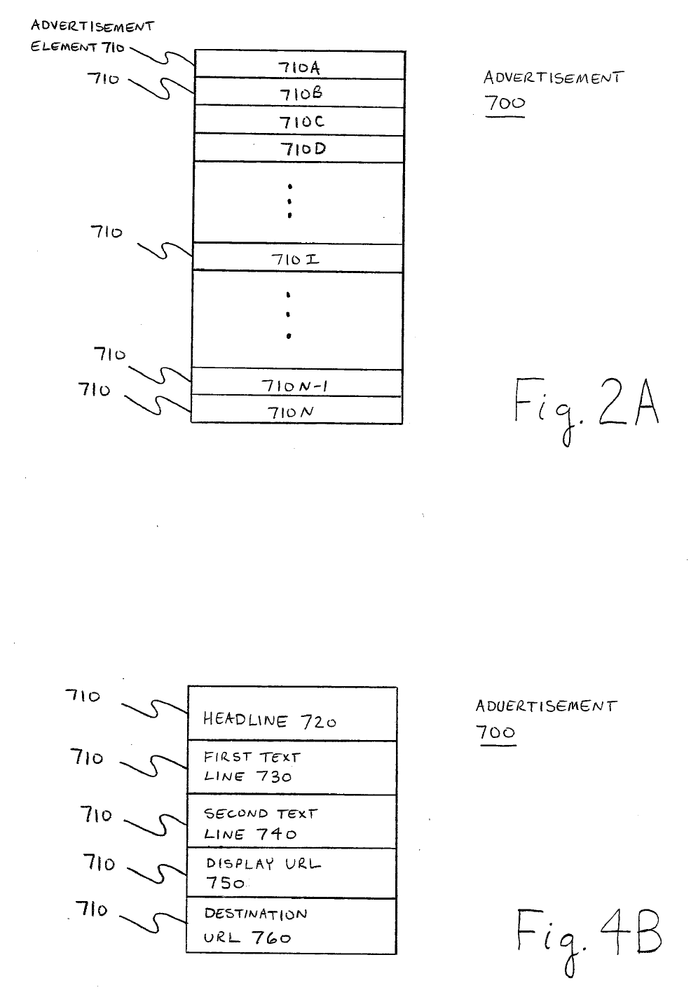

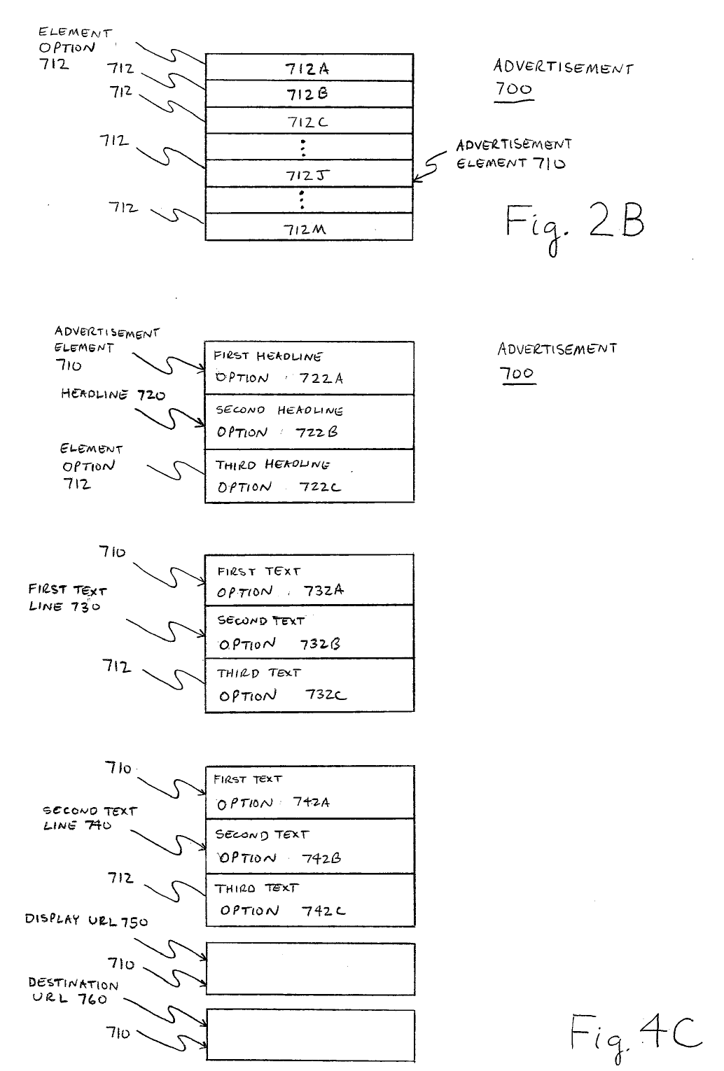

The advertising system 100 includes an advertising analysis system 200 for receiving an incoming advertisement 700 and for providing at least one more-effective advertisement 790 from the advertisement 700. Comprising a conventional advertisement, the advertisement 700 can be separated into, and/or associated with, any suitable number of advertisement elements 710 as shown in FIG. 2A. The advertisement elements 710 can include one or more textual advertisement elements and/or one or more graphical advertisement elements. Exemplary textual advertisement elements 710 can include one or more textual elements, such as headline information, description information, pricing information, promotional information, and/or contact information; whereas, a product picture is a typical graphical advertisement element. The advertisement elements 710 likewise can include one or more Internet advertisement elements, such as a display Uniform Resource Locator (URL) and/or a destination Uniform Resource Locator (URL).

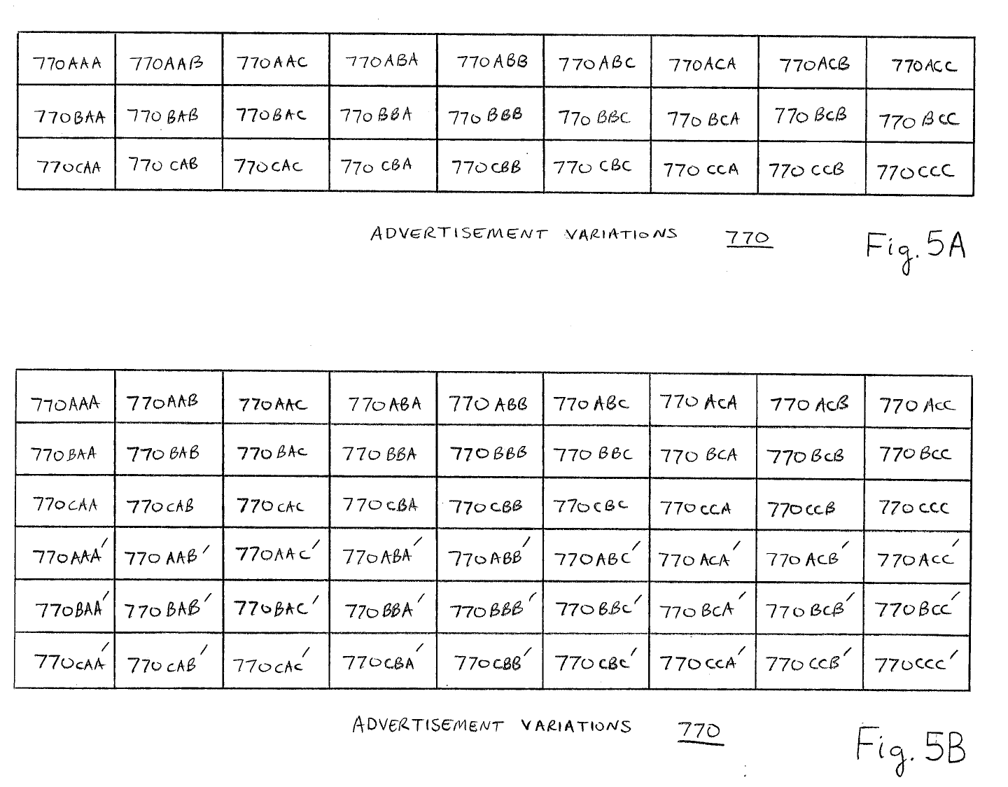

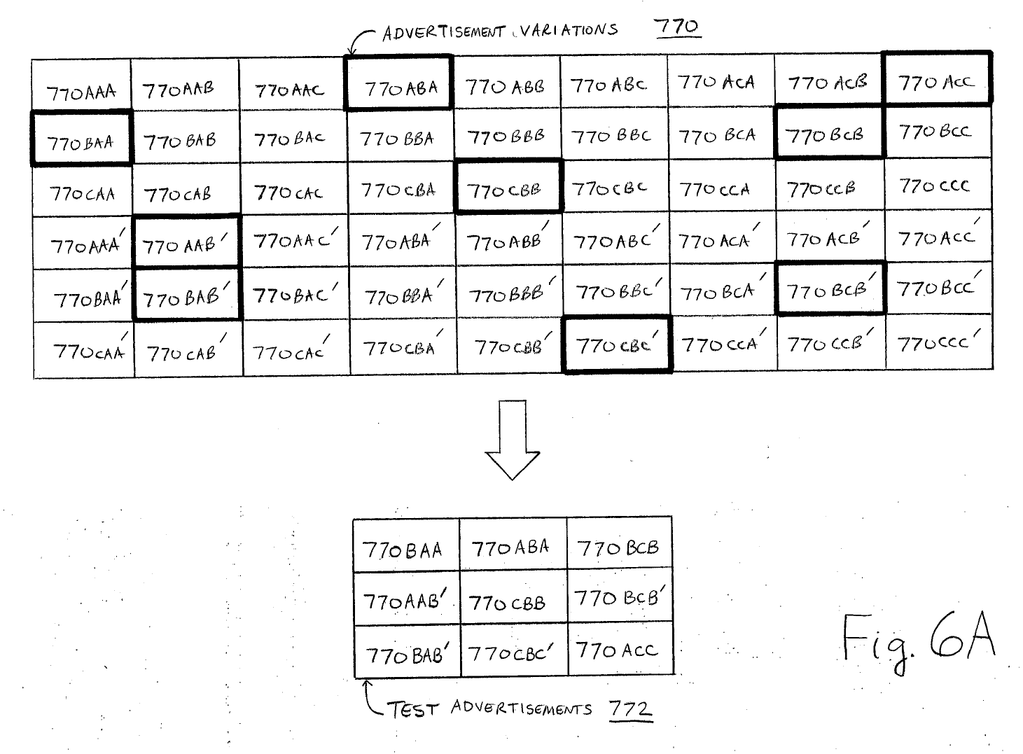

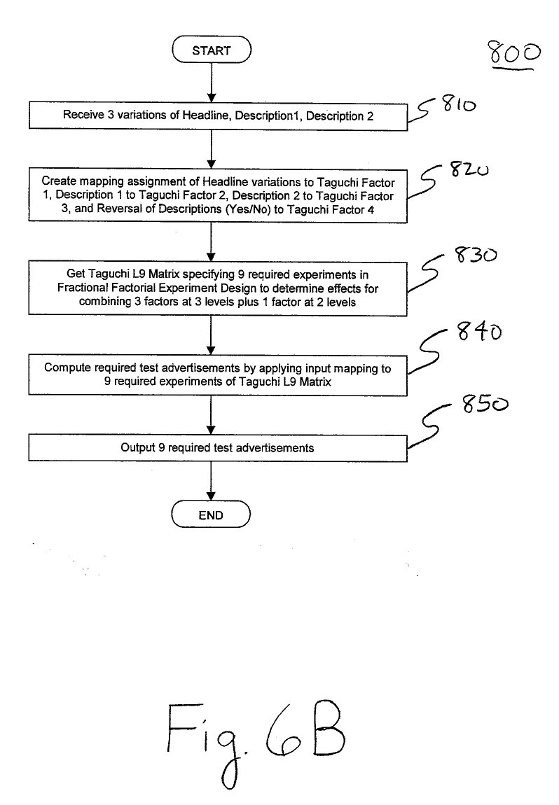

Further, the contents of one or more advertisement elements 710 can be modified. As illustrated in FIG. 2B, the exemplary advertisement element 710 can be associated with a plurality of element options 712 and can be modified by selecting one of the element options 712. If the advertisement element 710 includes headline information, for example, the element options 712 for the headline information can comprise different phrasing of the headline information. A predetermined number of advertisement variations 770 (shown in FIG. 5A) therefore are possible for the advertisement 700 by independently varying each of the advertisement elements 710. As desired, additional advertisement variations 770 (shown in FIG. 5B) can be provided by modifying an arrangement of the advertisement elements 710 within the advertisement 700.

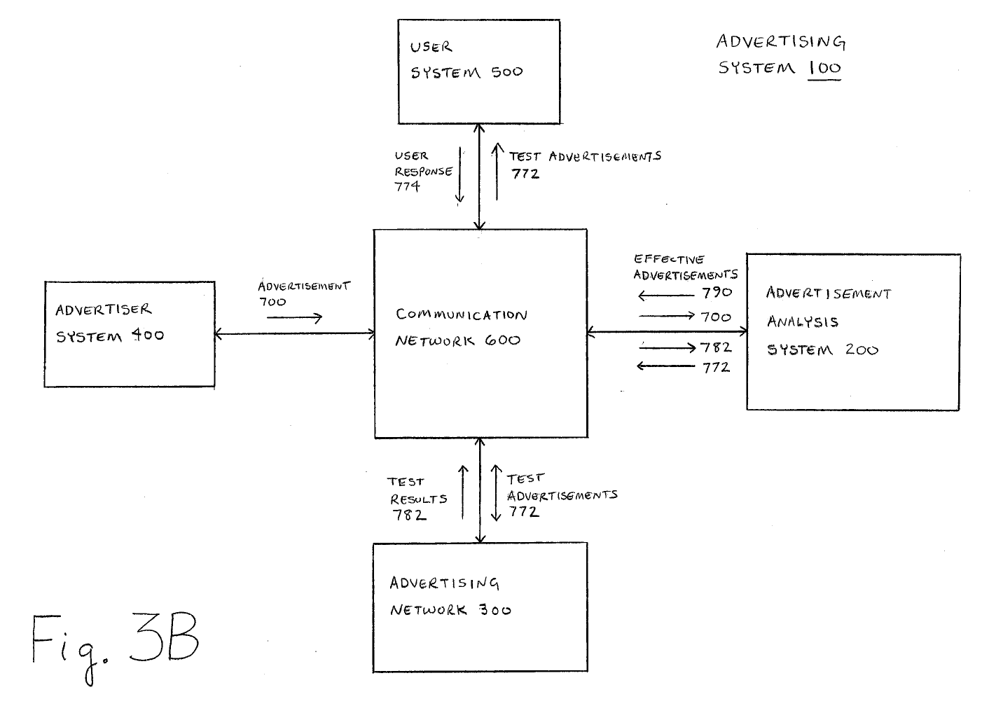

Retuning to FIG. 1, the advertising analysis system 200 likewise is shown as generating one or more test advertisements 772 from the advertisement 700. Analyzing each possible advertisement variation 770 of the advertisement 700, the advertising analysis system 200 can identify advertisement variations 770 with selected combinations of advertisement elements 710 as being optimal test cases and provide the identified advertisement variations 770 as the test advertisements 772. In this context, the term “optimal” can be defined as being the one or more advertisement variations 770 that are predicted to generate the highest and most profitable response. User response 774 (shown in FIG. 3B) to each test advertisement 772 is compiled during a predetermined test period and is provided to the advertising analysis system 200 as test results 782.

Based upon the test results 782 for the test advertisements 772, the advertising analysis system 200 can analyze the interrelation among the tested advertisement elements 710 and extrapolate the test results 782 to predict the effectiveness of each advertisement variation 770. The advertising analysis system 200 thereby can automatically provide a predetermined number of the advertisement variations 770 with the optimal predicted effectiveness as the more-effective advertisements 790 in a timely manner. As desired, the above advertisement analysis can be periodically repeated to update the more-effective advertisements 790 in order to account for any changing conditions within the relevant advertising domain. The above advertisement analysis can be repeated, for example, when the performance of the more-effective advertisements 790 decays below a preselected performance level and/or can include analyses of the original advertisement 700 and/or at least one new advertisement 700.

Typical configurations of the advertising system 100 are illustrated in FIGS. 3A-B. The exemplary configurations of the advertising system 100 of FIGS. 3A-B are not exhaustive and are provided for purposes of illustration only and not for purposes of limitation. In FIG. 3A, for example, the advertising system 100 is shown as further including an advertising network (or online advertising network or advertising network) 300 that is in communication with the advertising analysis system 200. Comprising a conventional advertising network, the advertising network 300 represent a plurality of vendors, often referred to as being advertising network partners, who sell advertising space to advertisers. On the Internet, for example, the advertising network 300 can include a plurality of Web sites for selling advertising and thereby allowing the advertisers to reach broad audiences relatively easily through run-of-category and run-of-network buys. Advantageously, the advertising network 300 can direct advertisements to unique combinations of targeted audiences by serving advertisements across multiple Web sites.

In the manner discussed in more detail above with reference to FIG. 1, the advertising analysis system 200 can be provided as a combination of one or more hardware components and/or software components for generating the test advertisements 772. As shown in FIG. 3A, the advertising analysis system 200 can provide the test advertisements 772 to the advertising network 300 for testing. The advertising network 300 can present the test advertisements 772 to one or more user systems 500 (shown in FIG. 3B) in order to measure the user response 774 (shown in FIG. 3B) to each test advertisement 772. During the predetermined test period, the advertising network 300 can present the test advertisements 772 to the user systems 500 in any conventional manner. The test advertisements 772, for example, can be presented in accordance with a preselected sequence. If the advertising network 300 cycles through the test advertisements 772, the test advertisements 772 can be approximately uniformly presented to the user systems 500. The advertising network 300 thereby can measure the user response 774 for each test advertisement 772.

The user response 774 to the test advertisements 772 likewise can be compiled and provided as the test results 782 in any conventional manner. During the predetermined test period, the advertising analysis system 200 can provide the test results 782 to the advertising analysis system 200 in real time and/or periodically. If the predetermined test period extends over a selected number of days, such as one week, for example, the advertising analysis system 200 can provide the test results 782 to the advertising analysis system 200 on a daily basis. As desired, the advertising analysis system 200 can provide the test results 782 to the advertising analysis system 200 at the end of the predetermined test period. Based upon the test results 782, the advertising analysis system 200 can analyze the interrelation among the tested advertisement elements 710 and extrapolate the test results 782 to predict the effectiveness of each advertisement variation 770 in the manner set forth above with reference to FIG. 1. The advertising analysis system 200 thereby can automatically provide the predetermined number of the advertisement variations 770 with the optimal predicted effectiveness as the more-effective advertisements 790 in a timely manner.

Turning to FIG. 3B, the advertising system 100 likewise can include at least one advertiser system 400 and/or at least one user system 500. The advertising analysis system 200, the advertising network 300, the advertiser system 400, and/or the user system 500 can communicate directly and/or indirectly, such as via a communication network 600 as illustrated in FIG. 3B. The communication network 600, for example, can be provided as a conventional wired and/or wireless communication network, including a telephone network, a local area network (LAN), a wide area network (WAN), the Internet, a campus area network (CAN), personal area network (PAN) and/or a wireless local area network (WLAN), of any kind. Exemplary wireless local area networks include wireless fidelity (Wi-Fi) networks in accordance with Institute of Electrical and Electronics Engineers (IEEE) Standard 802.11 and/or wireless metropolitan-area networks (MANs), which also are known as WiMax Wireless Broadband, in accordance with IEEE Standard 802.16.

Each of the advertiser systems 400 and the user systems 500 can comprise any conventional type of computer system, such as a personal computer system and/or a server system, and can connect with, and/or communicate with, the communication network 600 in any conventional manner. For example, if the communication network 600 is the Internet, the advertiser systems 400 and the user systems 500 can connect with the Internet via standard Internet Web Browser software.

The advertiser system 400, for example, is associated with an advertiser (or merchant) (not shown) and can provide the incoming advertisement 700 to the advertising analysis system 200 as illustrated in FIG. 3B. The advertising analysis system 200 thereby can collect data for ascertaining the current state of the advertiser's baseline advertisement campaign. As desired, the advertiser system 400 can include at least one advertisement element 710 and/or at least one element option 712 with the incoming advertisement 700. If the predetermined number of the more-effective advertisements 790 provided by the advertising analysis system 200 is selectable, the advertiser system 400 likewise can select the predetermined number of the advertisement variations 770 with the optimal predicted effectiveness to be provided as the more-effective advertisements 790. In other words, the advertiser system 400 can determine the predetermined number of the more-effective advertisements 790 to be provided by the advertising analysis system 200.

Each of the user systems 500 is associated with an associated user (or consumer) (not shown). During the predetermined test period, the user systems 500 each can receive the test advertisements 772 from the advertising analysis system 200 and/or the advertising network 300 in the manner discussed in more detail above with reference to FIGS. 1 and 3A. Preferably, the advertising analysis system 200 and/or the advertising network 300 provide the test advertisements 772 to a selected user system 500 in response to selected stimuli supplied by the associated user. The user system 500 can present one of the test advertisements 772 and can afford the user an opportunity to interact with the test advertisement 772. If the user elects to interact with the test advertisement 772, the user system 500 facilitates user interaction with the test advertisement 772 and can provide data regarding the user interaction as the user response 774 to the advertising analysis system 200 and/or the advertising network 300. The advertising analysis system 200 and/or the advertising network 300 thereby can compile the user response 774 as the test results 782 as set forth above.

Advantageously, the advertising system 100 can be utilized to create, test, analyze, and/or select online advertisements and webpages to generate the highest and most profitable user response over electronic communication networks, such as the Internet. The advertising system 100 can produce superior results by applying multivariate and statistical methodologies along with automated advertisement placement, data harvesting, and analysis. The advertising system 100 likewise can present an interactive interface (not shown), such as a graphical user interface (GUI), on the advertiser system 400. Via the intuitive interactive interface, the advertiser thereby can continuously interact with the advertising system 100 in real time, providing the advertisement 700, monitoring the test results 782 at any time during the predetermined test period, and/or selecting the predetermined number of the more-effective advertisements 790. Facilitating integration with the advertiser, the advertising system 100 can automatically generate the experimental design, provide intermediate performance feedback, and produce final optimized results. The intuitive interactive interface likewise can include an input advertisement creation system (not shown) for assisting the advertiser with the generation of new advertisement content for testing.

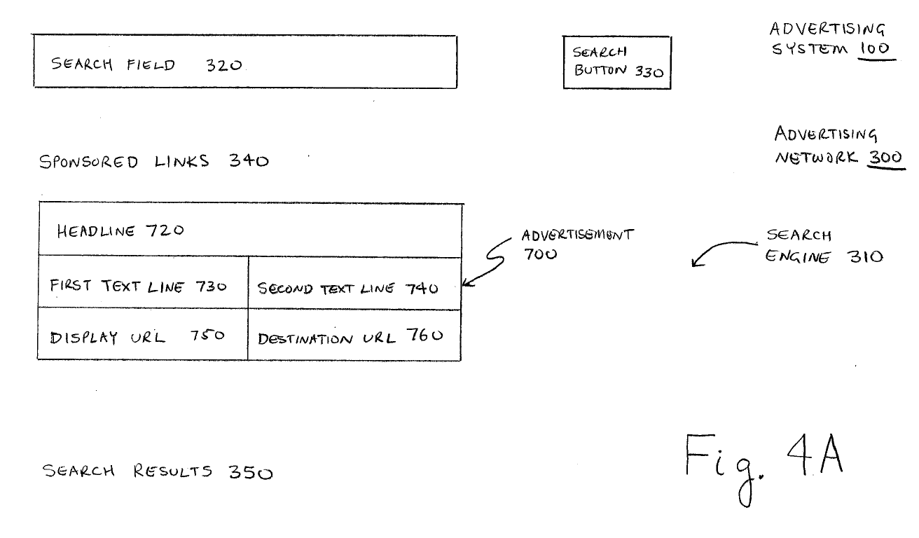

When the advertising system 100 is utilized to generate the more-effective advertisements 790 for distribution in electronic commerce via the Internet, exemplary advertising networks 300 can include a conventional search engine 310 for performing key word searching as illustrated in FIG. 4A. Exemplary search engines 310 can include Google, Yahoo, MSN or any other search engine and/or advertising network. Thereby, a user can enter one or more key words into a search field 320 of the search engine 310 and initiate an Internet search for the key words by clicking on the search button 330. The search engine 310 can respond by presenting one or more search results 350 that relate to the entered key words.

The search engine 310 likewise can provide one or more relevant advertisements 700, such as the test advertisements 772 and/or the more-effective advertisements 790, in a sponsored links frame 340 of the search engine 310. If the entered key words include a term that relates to the test advertisements 772 during the predetermined test period, for example, the search engine 310 can respond by including one of the test advertisements 772 in the sponsored links frame 340. In the manner set forth above, the search engine 310 can cycle through the test advertisements 772 such that a different test advertisement 772 can be presented with the search results 350 of subsequent key word searches.

Preferably, the advertising analysis system 200 can test for an interaction between one or more keywords and the test advertisements 772, such as advertisement copy of the test advertisements 772. Based upon this interaction, the advertising analysis system 200 can automatically adjust the advertising campaign structure so that the appropriate advertisement text appears with the appropriate keywords in an optimal manner. Currently, conventional advertisement networks 300 and search engines 310 provide the average best performing advertisement from the available group of advertisements for all keywords. In other words, the advertisement networks 300 and search engines 310 provide the one advertisement that, on average, is best for all keywords, not each keyword individually.

For example, if an advertiser has an advertisement group (or adgroup) with two thousand keywords, the advertisement networks 300 and search engines 310 typically will provide the one advertisement that, on average, is best for all two thousand keywords. The advertising analysis system 200, in contrast, can test the test advertisements 772 and measure the highest potential performing advertisement copy for each of the advertisement variations 770 (shown in FIGS. 5A-B). Thereby, the advertising analysis system 200 can automatically create one or more new advertisement groups. Each of the new advertisement groups include only the advertisement variations 770 that are the highest performing for the keywords associated with the new advertisement group.

The search engine 310 advantageously can be applied to receive and/or track the user response 774 (shown in FIG. 3B) to the presented test advertisement 772 and to compile the user response 774 to provide the test results 782 (shown in FIG. 3B) to the advertisement analysis system 200 as discussed above. Exemplary user responses 774 can include whether the user clicked on the relevant test advertisement 772, an extent to which the user navigated within the website associated with the test advertisement 772, whether the user interaction with the test advertisement 772 resulted in a sale, and/or whether the user interaction with the test advertisement 772 resulted in a download of promotional or other materials. In a similar manner, the search engine 310 can monitor the user response 774 to the more-effective advertisements 790, for example, to evaluate the performance level of the more-effective advertisements 790 after the predetermined test period.

As illustrated in FIGS. 4A-B, the advertisement 700 presented in the sponsored links frame 340 of the search engine 310 can include a plurality of the advertisement elements 710 in the manner discussed in more detail above with reference to FIG. 2A. Comprising typical advertisement elements 710 for online advertisements, the exemplary advertisement 700 is shown as including headline information 720, first and second text lines 730, 740, a display Uniform Resource Locator (URL) 750, and/or a destination Uniform Resource Locator (URL) 760. Each of the first and second text lines 730, 740 can include textual description information, pricing information, promotional information, and/or contact information for the advertisement 700. Although shown and described as including five specific advertisement elements 710 for purposes of illustration, the advertisement 700 can include any suitable type and number of advertisement elements 710.

One or more of the advertisement elements 710 of the exemplary advertisement 700 likewise can be associated any appropriate number of element options 712 in the manner discussed above with reference to FIG. 2B. Turning to FIG. 4C, for example, the headline information 720 is shown as being associated with a first headline option 722A, a second headline option 722B, and a third headline option 722C. The headline information 720 thereby can be modified by selecting one of the headline options 722A-C. Similarly, the first text line 730 can be associated with first, second, and third text options 732A-C; whereas, first, second, and third text options 742A-C can be associated with the second text line 740. The display Uniform Resource Locator (URL) 750 and the destination Uniform Resource Locator (URL) 760 each are shown in FIG. 4C as being associated with one advertisement element 710 and are not adjustable via a selection of advertisement elements 710. It is understood that the display Uniform Resource Locator (URL) 750 and/or the destination Uniform Resource Locator (URL) 760 can be associated with any suitable number of element options 712 as desired.

Upon receiving the exemplary advertisement 700 from the advertiser, the advertising analysis system 200 can apply the element options 712 to each of the advertisement elements 710 to generate the predetermined number of possible advertisement variations 770 as shown in FIG. 5A. As set forth above, the headline information 720 and the first and second text lines 730, 740 each are shown as being associated with three element options 712; whereas, the display Uniform Resource Locator (URL) 750 and the destination Uniform Resource Locator (URL) 760 each are associated with one advertisement element 710. Therefore, by varying the element options 712, the advertising analysis system 200 can generate the twenty-seven possible advertisement variations 770AAA-CCC illustrated in FIG. 5A. For purposes of clarity, each of the advertisement variations 770 is shown as being in the format “770XYZ”, wherein the “X” is associated with the selected headline option 722A-C, the “Y” is associated with the selected text option 732A-C, and the “Z” is associated with the selected text option 742A-C. In other words, the advertisement variation 770ABC represents the advertisement variation 770 with the first headline option 722A, the second text option 732B, and the third text option 742C. Additional advertisement variations 770 may be generated by including one or more additional element options 712 with the advertisement 700.

As desired, additional advertisement variations 770 likewise can be provided by modifying an arrangement of the advertisement elements 710 within the advertisement 700. Turning to FIG. 5B, for example, the possible advertisement variations 770 are shown for the advertisement 700 when the positions of the first and second text lines 730, 740 within the advertisement 700 are interchangeable (and/or reversible). The advertisement variations 770 of FIG. 5B therefore include the twenty-seven advertisement variations 770AAA-CCC discussed above with reference to FIG. 5A as well as advertisement variations 770AAA′-CCC′, wherein the advertisement variations 770AAA′-CCC′ comprise the twenty-seven additional advertisement variations 770 that are possible when the positions of the first and second text lines 730, 740 are exchanged within the advertisement 700. Thereby, a total of fifty-four advertisement variations 770AAA-CCC, 770AAA′-CCC′ are possible when the positions of the first and second text lines 730, 740 are interchangeable. As desired, additional advertisement variations 770 may be generated by permitting additional the advertisement elements 710 to be interchangeable within the advertisement 700 as illustrated in FIG. 5B.

In the manner discussed above with reference to FIG. 1, the advertising analysis system 200 (shown in FIG. 1) can generate a predetermined number of test advertisements 772 from the advertisement 700. By analyzing each possible advertisement variation 770AAA-CCC, 770AAA′-CCC′ of the advertisement 700, the advertising analysis system 200 can identify advertisement variations 770 with selected combinations of advertisement elements 710 as being optimal test cases and provide the identified advertisement variations 770 as the test advertisements 772. Although the advertising analysis system 200 can perform the analysis in any conventional manner, the advertising analysis system 200 preferably employs multivariate testing (or experiment) methodologies, such as the robust (or Taguchi) design method and fractional factorial experiment (FFE) design method, to analyze the advertisement variations 770 and to identify the optimal test cases.

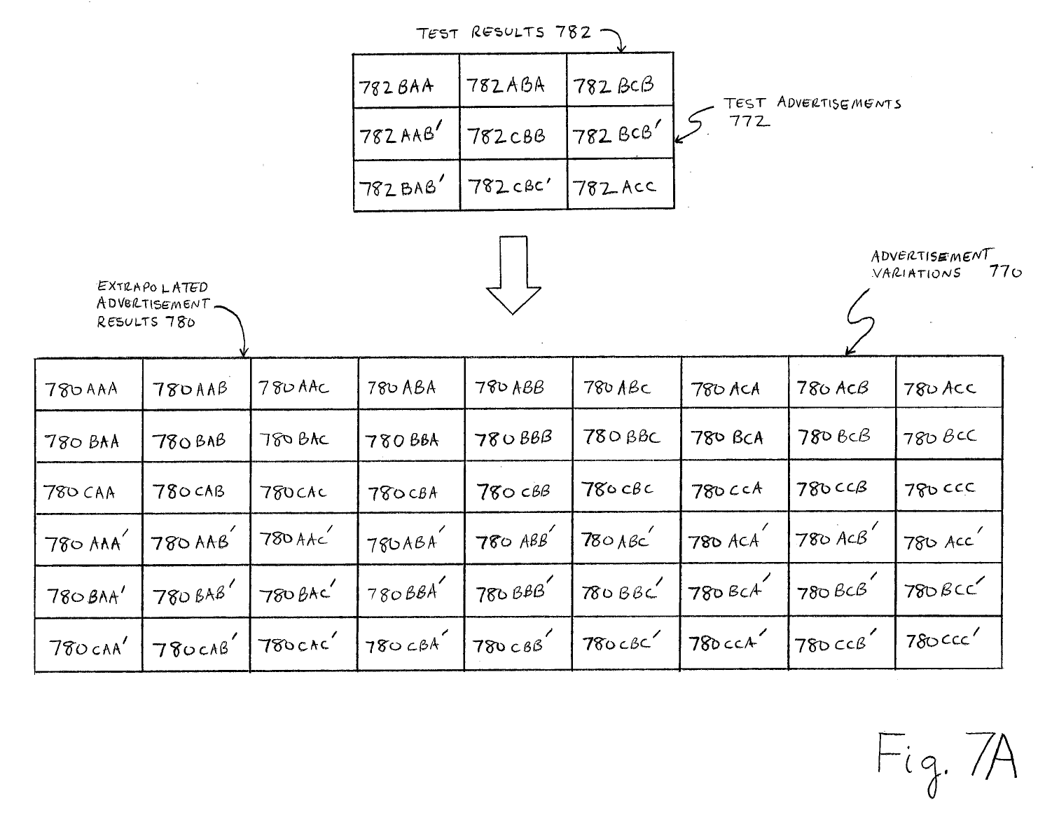

The application of the multivariate testing methodologies for selecting the test advertisements 772 is shown and described with reference to FIGS. 6A-B. By applying the multivariate testing methodologies, the advertising analysis system 200 (shown in FIG. 1) can create a design for the test (or experiment). The advertising analysis system 200 thereby can automatically identify the different advertisement variations 770 with selected combinations of advertisement elements 710 to be provided as the test advertisements 772 for each test trial and provide the test advertisements 772 to the advertising network 300 (shown in FIGS. 3A-B) and/or search engine 310 (shown in FIG. 4A). Turning to FIG. 6A, the test advertisements 772 are shown as comprising nine advertisement variations 770 selected from among the fifty-four possible advertisement variations 770AAA-CCC, 770AAA′-CCC′ of the advertisement 700. Although shown and described as comprising nine advertisement variations 770 for purposes of illustration, the test advertisements 772 can include any suitable number of the fifty-four possible advertisement variations 770AAA-CCC, 770AAA′-CCC′, as desired.

The operation of the advertising analysis system 200 is discussed with reference to the exemplary method 800 for selecting the test advertisements 772 as shown in FIG. 6B. Although shown and described as comprising as a selected sequence of operations 810-850 for purposes of illustration, the advertising analysis system 200 can select the test advertisements 772 in any suitable manner. The exemplary method 800 begins at 810, wherein the advertising analysis system 200 receives the advertisement 700 with the three headline options 722A-C, the three text options 732A-C, and the three text options 742A-C in the manner discussed above with reference to FIG. 4C. At 820, the advertising analysis system 200 creates an input mapping assignment between each of the variable advertisement elements 710 and a selected Taguchi factor. The headline options 722A-C for the headline information 720 are shown as being mapped to Taguchi Factor 1; whereas, the text options 732A-C for the first text line 730 and the text options 742A-C for the second text line 740 are respectively mapped to Taguchi Factor 2 and Taguchi Factor 3. The exchangeable positions of the first and second text lines 730, 740 within the advertisement 700 likewise are mapped to Taguchi Factor 4.

At 830, the advertising analysis system 200 retrieves and/or generating a Taguchi L9 matrix (or array). The Taguchi L9 matrix specifies the nine tests (or experiments) in a fractional factorial experiment design for determining an effect for combining the Taguchi Factor 1, the Taguchi Factor 2, and the Taguchi Factor 3 for the headline information 720, the first text line 730, and the second text line 740, respectively, with the Taguchi Factor 4 for the exchangeable positions of the first and second text lines 730, 740 within the advertisement 700. The advertising analysis system 200 computes the nine test advertisements 772 by applying the input mapping assignment to the nine tests of the Taguchi L9 matrix in the fractional factorial experiment design, at 840. Upon computing the test advertisements 772, the advertising analysis system 200, at 850, provides the test advertisements 772 to the advertising network 300 and/or the search engine 310 for testing during the predetermined test period in the manner discussed in more detail above. The advertising analysis system 200 thereby generates the nine optimal test advertisements 772 as illustrated in FIG. 6A.

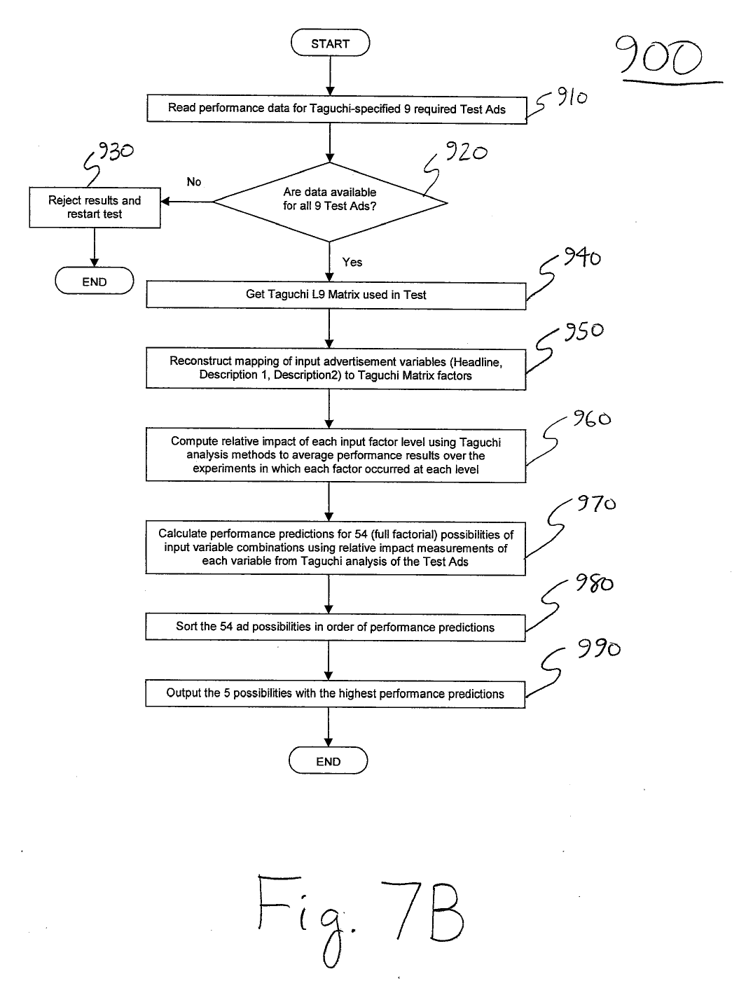

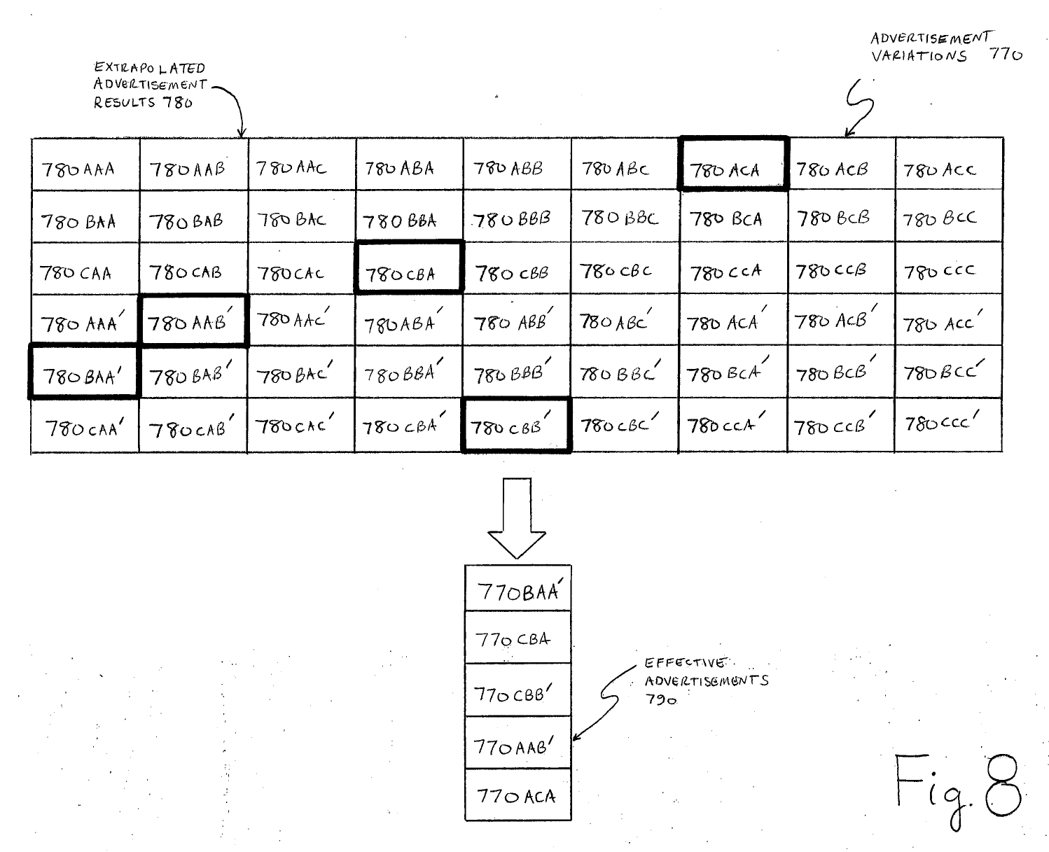

As discussed above, the advertising analysis system 200 can receive and compile the user response 774 (shown in FIG. 3B) to the test advertisements 772 as the test results 782. The advertising analysis system 200, based upon the test results 782, can analyze the interrelation among the tested advertisement elements 710 and extrapolate the test results 782 to predict the effectiveness of each advertisement variation 770. FIGS. 7A-B illustrate exemplary extrapolated advertisement results 780 for the test advertisements 772 of FIGS. 6A-B. As shown in FIG. 7A, the test results 782 include nine sets of test results 782. In other words, each of the nine optimal test advertisements 772 is associated with one set of the test results 782. The test results 782ABA, for example, are associated with the test advertisement 772ABA.

An exemplary method 900 by which the advertising analysis system 200 can extrapolate the test results 782 to generate the extrapolated advertising results 780 for predicting the effectiveness of each of the possible advertisement variations 770 is illustrated in FIG. 7B. At 910, the advertising analysis system 200 is shown as receiving and/or reading the test results 782 for each of the nine optimal test advertisements 772. The advertising analysis system 200, at 920, examines the test results 782 to confirm whether test results 782 are available for each of the nine optimal test advertisements 772. If not, the advertising analysis system 200 can reject the test results 782 and restart the testing of the nine optimal test advertisements 772, at 930. Otherwise, the advertising analysis system 200 can proceed with the extrapolation of the test results 782.

At 940, the advertising analysis system 200 is illustrated as retrieving the Taguchi L9 matrix used in the testing. The advertising analysis system 200, at 950, reconstructs the input mapping assignment between the variable advertisement elements 710 and the selected Taguchi factors as discussed in more detail above with reference to FIG. 6B. At 960, the advertising analysis system 200 applies Taguchi analysis methodology to compute a relative impact of each of the Taguchi Factor 1, the Taguchi Factor 2, the Taguchi Factor 3, and the Taguchi Factor 4 to average test results 782 over the tests in which each Taguchi Factor occurred at each level. The advertising analysis system 200 thereby can use the relative impact of each Taguchi Factor, at 970, to predict the effectiveness of each of the fifty-four possible advertisement variations 770 and to provide the extrapolated advertisement results 780 as shown in FIG. 7A. Stated somewhat differently, each of the advertisement variations 770 (shown in FIG. 6A) is associated with an extrapolated advertisement result 780 (shown in FIG. 7A). The test results 780BBC′, for example, are associated with the advertisement variation 770BBC′.

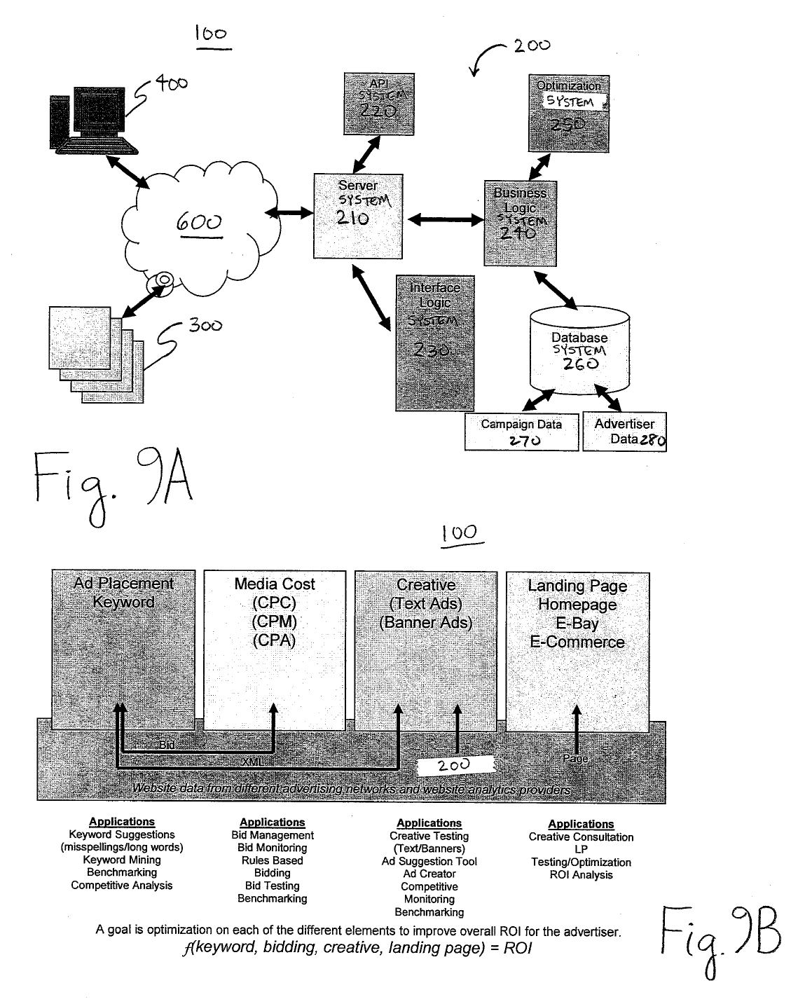

Upon predicting the effectiveness of each of the possible advertisement variations 770, the advertising analysis system 200 can sort the possible advertisement variations 770 in order of the extrapolated advertisement results 780, at 980. The advertising analysis system 200, at 990, then can provide a preselected number of the possible advertisement variations 770 with the best extrapolated advertisement results 780 as the more-effective advertisements 790. For example, the advertising analysis system 200 can provide five advertisement variations 770 with the best extrapolated advertisement results 780 as the more-effective advertisements 790 as illustrated in FIGS. 7B and 8. If the five best extrapolated advertisement results 780 are the extrapolated advertisement results 780BAA′, 780CBA, 780CBB′, 780AAB′, and 780ACA, for example, the advertising analysis system 200 can provide the advertisement variations 770BAA′, 770CBA, 770CBB′, 770AAB′, and 770ACA as the more-effective advertisements 790. The advertising analysis system 200 thereby can automatically provide a predetermined number of the advertisement variations 770 with the optimal predicted effectiveness as the more-effective advertisements 790 in a timely manner.

Although shown and described with reference to FIGS. 6A-B and 7A-B as being applied to four Taguchi Factors with three levels for purposes of illustration, the Taguchi design method can be applied to any suitable number of Taguchi Factors with any predetermined number of levels. Based upon the number of Taguchi Factors and the number of levels, the advertising analysis system 200 can generate an appropriate Taguchi matrix (or array), which also determines the number of the test advertisements 772 to be analyzed during the predetermined test period. Exemplary Taguchi matrices for selected numbers of Taguchi Factors with various levels are illustrated in Table 1 below. The Taguchi matrices shown in Table 1 are not exhaustive and are provided for purposes of illustration only and not for purposes of limitation.

TABLE 1
Taguchi matrices for selected numbers
of Taguchi Factors with various levels

| Number | | | | |
|---|---|---|---|---|
| of Taguchi | Number of Levels | | | |
| Factors | 2 | 3 | 4 | 5 |
| 2 | Taguchi L4 | Taguchi L9 | Taguchi L16 | Taguchi L25 |
| | Matrix | Matrix | Matrix | Matrix |
| 3 | Taguchi L4 | Taguchi L9 | Taguchi L16 | Taguchi L25 |
| | Matrix | Matrix | Matrix | Matrix |
| 4 | Taguchi L8 | Taguchi L9 | Taguchi L16 | Taguchi L25 |
| | Matrix | Matrix | Matrix | Matrix |
| 5 | Taguchi L8 | Taguchi L18 | Taguchi L16 | Taguchi L25 |
| | Matrix | Matrix | Matrix | Matrix |
| 6 | Taguchi L8 | Taguchi L18 | Taguchi L32 | Taguchi L25 |
| | Matrix | Matrix | Matrix | Matrix |
| 7 | Taguchi L8 | Taguchi L18 | Taguchi L32 | Taguchi L50 |
| | Matrix | Matrix | Matrix | Matrix |
| 8 | Taguchi L12 | Taguchi L27 | Taguchi L32 | Taguchi L50 |
| | Matrix | Matrix | Matrix | Matrix |
| 9 | Taguchi L12 | Taguchi L27 | Taguchi L32 | Taguchi L50 |
| | Matrix | Matrix | Matrix | Matrix |
| 10 | Taguchi L12 | Taguchi L27 | Taguchi L32 | Taguchi L50 |
| | Matrix | Matrix | Matrix | Matrix |
| 11 | Taguchi L12 | Taguchi L27 | | Taguchi L50 |
| | Matrix | Matrix | | Matrix |
| 12 | Taguchi L16 | Taguchi L27 | | Taguchi L50 |
| | Matrix | Matrix | | Matrix |
| 13 | Taguchi L16 | Taguchi L27 | | |
| | Matrix | Matrix | | |
| 14 | Taguchi L16 | Taguchi L36 | | |
| | Matrix | Matrix | | |
| 15 | Taguchi L16 | Taguchi L36 | | |
| | Matrix | Matrix | | |
| 16 | Taguchi L32 | Taguchi L36 | | |
| | Matrix | Matrix | | |
| 17 | Taguchi L32 | Taguchi L36 | | |
| | Matrix | Matrix | | |
| 18 | Taguchi L32 | Taguchi L36 | | |
| | Matrix | Matrix | | |
| 19 | Taguchi L32 | Taguchi L36 | | |
| | Matrix | Matrix | | |
| 20 | Taguchi L32 | Taguchi L36 | | |
| | Matrix | Matrix | | |
| 21 | Taguchi L32 | Taguchi L36 | | |
| | Matrix | Matrix | | |
| 22 | Taguchi L32 | Taguchi L36 | | |
| | Matrix | Matrix | | |
| 23 | Taguchi L32 | Taguchi L36 | | |
| | Matrix | Matrix | | |
| 24 | Taguchi L32 | | | |
| | Matrix | | | |
| 25 | Taguchi L32 | | | |
| | Matrix | | | |
| 26 | Taguchi L32 | | | |
| | Matrix | | | |
| 27 | Taguchi L32 | | | |
| | Matrix | | | |
| 28 | Taguchi L32 | | | |
| | Matrix | | | |
| 29 | Taguchi L32 | | | |
| | Matrix | | | |
| 30 | Taguchi L32 | | | |
| | Matrix | | | |
| 31 | Taguchi L32 | | | |
| | Matrix | | | |

Therefore, the advertising analysis system 200 can enable advertisers to rapidly test and find the best advertisements as measured by advertiser-defined metrics (i.e. customer response, return on investment (ROI) or impressions (views)) with a high statistical reliability. The advertising analysis system 200 provides simple methods and easily interpreted results so that any person, including persons who are not experts in the field, can produce optimized advertisements that are equal to those produced by professional firms.

Advertisements thereby can be tested much more rapidly and interactions between elements can be uncovered. Advertisements can be tested more rapidly than with standard testing techniques because the system implements a technique wherein the system statistically infers the best advertisement variation but tests only a small fraction of the entire sample space. The system does this with a minimal impact on the statistical power of the experiments. The advertising analysis system 200 then produces test results much more rapidly because it requires smaller sample sizes than standard techniques. Additionally the advertising analysis system 200 can extrapolate its results along many dimensions rather than the comparatively small inferences available through standard (A/B) tests.

The advertising analysis system 200 also provides an end-to-end solution for optimization of the entire advertising process from generation of keywords to the correct choice of “landing page” (destination for the action called for in the advertisement). Multivariable testing had in the past always been applied to manufacturing type situations where discreet settings could be provided for individual trials. In contrast to the advertising analysis system 200, fractional factorial experiment (FFE) testing was developed for and has been restricted to analysis of optimization in the field of manufacturing and process control. Each step in the process is a factor and each factor may have several conditions. Researchers in this field have developed statistical techniques that allow testing of a small subset of all permutations of factors and conditions that allow inference across the entire space of possibilities.

The application of these techniques for the optimization of advertisement content has other advantages. Experts in the field typically perceive advertisement copy as atomic and immutable. The disclosed technique advantageously includes modeling an advertisement as a set of small interchangeable parts that can be modeled like a manufacturing process. First, it allows the generation of potentially radically different sets of copy to be tested in an integrated matter, producing permutations of advertisement copy that would not have been created. Within this framework, fractional factorial experiment (FFE) design techniques can be applied to determine which permutations of advertisements produce optimal results for each given metric where the optimal advertisement may never have been explicitly displayed within the pilot test.

Application of the advertising analysis system 200 can provide a lift (increase in performance) as measured by conversion rates of between approximately 25% and 400% or more after conclusion of the testing period. The advertising analysis system 200 likewise serves a need for automatically producing, testing and recommending advertisements for business people who lack sufficient understanding of the optimization process.

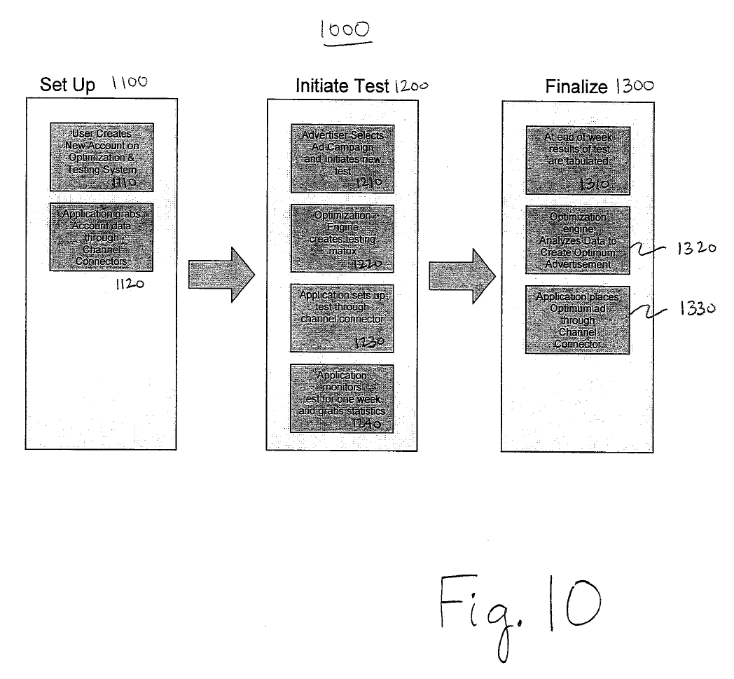

A preferred embodiment of the advertising system 100 is illustrated in FIG. 9A, wherein the advertising analysis system 200 is illustrated as including a server system 210. The server system 210 provides one or more interface systems for facilitating interactions between the advertising analysis system 200 and other system components of the advertising system 100, and one or more application services can reside on the server system 210. As desired, the interface systems can be provided in any conventional manner. As shown in FIG. 9, the interface systems can be provided via an application programming interface (API) system 220 and/or an interface logic system 230, which are in communication with the server system 210.

The application programming interface system 220, for example, can include an advertising network interface system (not shown) for interfacing the advertising analysis system 200 with one or more of the advertising networks 300. Since the advertising networks 300 typically use various models for organizing and delivering advertisements, the advertising network interface system can provide custom interaction with the different interfaces provided by the advertising networks 300 in order for the advertising analysis system 200 to perform the tasks necessary for advertisement optimization. These tasks include obtaining data about existing advertisement campaigns, placing experimental advertisements on the advertising network 300, gathering ongoing performance metrics for advertisements, and placing optimized advertisements on the advertising network 300. Furthermore, information obtained from the advertising network 300 can be stored for use by the other components of the advertising analysis system 200. Each advertising network 300 may require slightly different programs for performing these tasks.

An advertiser (or user) interface system (not shown) likewise can be included with the application programming interface system 220. The advertiser interface system facilitate bidirectional interaction between the advertising analysis system 200 and the advertiser system 400 and/or the user system 500 (shown in FIG. 3B). Thereby, incoming information can be received from, and outputted information can be provided to, the advertiser system 400 and/or the user system 500. The user's primary access method of the advertising analysis system 200 is through the use of a conventional Internet web browser, such as Internet Explorer. The web browser can be used to access the advertising analysis system 200, for example, via a website. The web pages associated with the advertising analysis system 200 can provide links, buttons, and/or forms, which the browser allows the advertiser and/or user to click on and/or enter information in a conventional manner.

When an advertiser or user clicks on a link or button, the browser can send a request to the advertising analysis system 200 using the HyperText Transport (or Transfer) Protocol (HTTP) Internet communication protocol and/or the Secure HTTP (HTTPS) Internet communication protocol, possibly containing information that the advertiser and/or the user entered into the browser. The advertising analysis system 200 thereby can receive the request, execute business logic in response to the request, and send a response back to the browser of the advertiser and/or user. The browser of the advertiser and/or user browser display thereby can be updated. Thus, the advertiser and/or user can interact with the advertising analysis system 200 for such purposes as uploading baseline advertising network performance data, starting tests on the advertising network 300, viewing ongoing test performance, and completing tests by uploading optimal advertisements to the advertising network 300.

As illustrated in FIG. 9A, the advertising analysis system 200 likewise can include a business logic system 240 and an optimization system (or engine) 250, comprising software and data storage systems. The business logic system 240 and an optimization system (or engine) 250 can read and write persistent data to a database system 260. The database system 260, in turn, can include information about each advertiser's account on the advertising network 300 and the structure of those accounts, can test that a selected advertiser is running, and can compile performance data for the advertiser's accounts. The advertising analysis system 200 preferably is designed in a modular fashion, providing a storage system for campaign data 270 and/or a storage system for advertiser data 280.

FIG. 9B illustrates an embodiment of the optimization system 250. The optimization system 250 enables the advertising analysis system 200 to optimize the performance of an online advertising campaign. Online advertising campaigns typically include a plurality of areas of optimization. Exemplary areas of optimization for online advertising campaigns can include keyword/placement, media cost, creative, and landing page. Data likewise can be an important component culled through relationships among analytics providers, advertising networks, and/or e-commerce shopping cart providers.

FIG. 10 shows an exemplary application flow 1000 for the advertising analysis system 200. The application flow 1000 is illustrated as being divided into three primary stages, including a set up stage 1100, a test initiation stage 1200, and a test finalization stage 1300. During the set up stage 1100, an advertiser, at 1110, can create a new user account on the advertising analysis system 200. At 1120, the application can grab account data for the new account through channel connectors. Once the new user account has been established, the advertiser can choose an advertising campaign and initiate a new test, at 1210. At 1220, the optimization system 250 (shown in FIG. 9A) can create a testing matrix, and the application sets up the test through the channel connector, at 1230. Thereafter, the advertiser, at 1240, can monitor the test during the predetermined test period and can compile test statistics. After the predetermined test period, the application flow 1000 can enter the test finalization stage 1300, wherein, at 1310, the test results 782 (shown in FIG. 1) are tabulated (or compiled). The optimization system 250 analyzes test results 782, at 1320, to create the more-effective advertisements 790 (shown in FIG. 1). At 1330, the advertising analysis system 200 can provide the more-effective advertisements 790 via the channel connector.

The invention is susceptible to various modifications and alternative forms, and specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives.

What is claimed is:

1. A method for generating an effective advertisement, comprising:
receiving an advertisement having a plurality of advertisement elements;
modifying at least one of the advertisement elements to generate a plurality of advertisement variations for the incoming advertisement;
applying multivariate testing to the plurality of advertisement variations to identify at least one test advertisement, each of the at least one test advertisement being an optimal test case and comprising a selected combination of the advertisement elements;
compiling user response to each of the at least one test advertisement during a predetermined test period;
performing multivariate testing on the user response to analyze an interrelation among the advertisement elements to predict an effectiveness of each of the advertisement variations;
comparing the predicted effectiveness of each of the advertisement variations to identify a selected advertisement variation with a highest predicted effectiveness; and
providing the selected advertisement variation as the effective advertisement.

2. The method of claim 1, wherein said receiving the advertisement comprises receiving the advertisement with advertisement in which a predetermined advertisement element is associated with a plurality of element options and wherein said generating the plurality of the advertisement variations includes selecting one of the element options for the predetermined advertisement element.

3. The method of claim 1, wherein said generating the plurality of the advertisement variations includes rearranging the at least one of the advertisement elements within the advertisement.

4. The method of claim 1, wherein said applying multivariate testing to the plurality of advertisement variations comprises applying multivariate testing to the plurality of advertisement variations in accordance with a methodology selected from the group consisting of the Taguchi design method and fractional factorial experiment design method.

5. The method of claim 4, wherein said applying multivariate testing to the plurality of advertisement variations includes creating an input mapping assignment between each of the advertisement elements and a selected Taguchi factor, generating a Taguchi matrix to specify a predetermined number of experiments in a fractional factorial experiment design to determine an effect for each of the advertisement variations, applying the input mapping assignment to each of the experiments in accordance with the Taguchi matrix to provide the at least one test advertisement.

6. The method of claim 5, wherein said generating the Taguchi matrix comprises generating the Taguchi matrix selected from the group consisting of a Taguchi L4 matrix, a Taguchi L8 matrix, a Taguchi L9 matrix, a Taguchi L12 matrix, a Taguchi L16 matrix, a Taguchi L18 matrix, a Taguchi L25 matrix, a Taguchi L27 matrix, a Taguchi L32 matrix, a Taguchi L36 matrix, and a Taguchi L50 matrix.

7. The method of claim 5, wherein said performing multivariate testing on the user response comprises performing multivariate testing on the user response in accordance with a methodology selected from the group consisting of the Taguchi design method and fractional factorial experiment design method.

8. The method of claim 7, wherein said performing multivariate testing on the user response includes determining whether the user response is available for each of the at least one test advertisement and, if the user response is not available for at least one of the at least one test advertisement, rejecting the user response and again compiling the user response to each of the at least one test advertisement during a subsequent predetermined test period.

9. The method of claim 7, wherein said performing multivariate testing on the user response includes retrieving the Taguchi matrix with the user response, reconstructing the input mapping assignment, applying Taguchi methodology to determine a relative impact for each of the advertisement variations, and using the relative impact to predict the effectiveness of each of the advertisement variations.

10. The method of claim 1, wherein said comparing the predicted effectiveness of each of the advertisement variations comprises comparing the predicted effectiveness of each of the advertisement variations to identify a predetermined number of selected advertisement variations with highest predicted effectiveness, and wherein said providing the selected advertisement variation as the effective advertisement comprises providing each of the predetermined number of selected advertisement variations as the effective advertisement.

11. The method of claim 10, wherein said providing the selected advertisement variation includes selecting the predetermined number of the selected advertisement variations to be provided as the effective advertisement.

12. The method of claim 1, further comprising updating the effective advertisement by repeating said applying the multivariate testing to the plurality of advertisement variations, said compiling the user response to each of the at least one test advertisement, said performing the multivariate testing on the user response, and said comparing the predicted effectiveness of each of the advertisement variations.

13. The method of claim 12, wherein said updating the effective advertisement comprises periodically updating the effective advertisement to account for any changing conditions within the relevant advertising domain.

14. An advertising analysis system for providing at least one effective advertisement from an incoming advertisement having a plurality of advertisement elements, comprising:
an input port that receives the incoming advertisement;
an output port that provides the at least one effective advertisement; and
a processing system that receives the incoming advertisement from said input port and modifies at least one of the advertisement elements to generate a plurality of advertisement variations for the incoming advertisement, said processing system applying multivariate testing to the plurality of advertisement variations to identify at least one test advertisement each being an optimal test case and comprising a selected combination of the advertisement elements, compiling user response to each of the at least one test advertisement during a predetermined test period, and performing multivariate testing on the user response to analyze an interrelation among the advertisement elements to predict an effectiveness of each of the advertisement variations,
wherein said processing system compares the predicted effectiveness of each of the advertisement variations to identify a selected advertisement variation with a highest predicted effectiveness and provides the selected advertisement variation to said output port as the effective advertisement.

15. The advertising analysis system of claim 14, wherein the plurality of advertisement elements are selected from the group consisting of at least one textual advertisement element, at least one graphical advertisement element, and at least one Internet advertisement elements.

16. The advertising analysis system of claim 15, wherein the plurality of advertisement elements are selected from the group consisting of headline information, description information, pricing information, promotional information, contact information, a display Uniform Resource Locator, and a destination Uniform Resource Locator.

17. The advertising analysis system of claim 14, wherein a predetermined advertisement element is associated with a plurality of element options and wherein said processing system modifies the predetermined advertisement element by selecting one of the element options.

18. The advertising analysis system of claim 14, wherein said processing system modifies the predetermined advertisement element by rearranging the at least one of the advertisement elements within the incoming advertisement.

19. The advertising analysis system of claim 14, wherein said processing system applies said multivariate testing to the plurality of advertisement variations and performs said multivariate testing on the user response each in accordance with a methodology selected from the group consisting of the Taguchi design method and fractional factorial experiment design method.

20. The advertising analysis system of claim 14, wherein said processing system compiles the user response to each of the at least one test advertisement by providing the at least one test advertisement to an advertising network and receiving the user response from the advertising network.

21. An advertising system, comprising:
an advertising analysis system that receives an incoming advertisement having a plurality of advertisement elements, said advertising analysis system modifying at least one of the advertisement elements to generate a plurality of advertisement variations for the incoming advertisement and applying multivariate testing to the plurality of advertisement variations to identify at least one test advertisement, each of the at least one test advertisement being an optimal test case and comprising a selected combination of the advertisement elements; and
an advertising network that receives the at least one test advertisement from said advertising analysis system and that receives user response to each of the at least one test advertisement during a predetermined test period,
wherein said advertising analysis system compiles the user response and performs multivariate testing on the user response to analyze an interrelation among the advertisement elements to predict an effectiveness of each of the advertisement variations, said advertising analysis system comparing the predicted effectiveness of each of the advertisement variations to identify a selected advertisement variation with a highest predicted effectiveness and providing the selected advertisement variation as an effective advertisement.

22. The advertising system of claim 21, wherein said advertising analysis system applies said multivariate testing to the plurality of advertisement variations and performs said multivariate testing on the user response each in accordance with a methodology selected from the group consisting of the Taguchi design method and fractional factorial experiment design method.

23. The advertising system of claim 21, wherein said advertising analysis system and said advertising network communicate via a communication network.

24. The advertising system of claim 23, wherein said communication network comprises the Internet.

25. The advertising system of claim 21, further comprising an advertiser system that provides the incoming advertisement to said advertising analysis system.

26. The advertising system of claim 21, wherein the effective advertisement is selectable via said advertiser system.

27. The advertising system of claim 21, further comprising at least one user system that receives the at least one test advertisement from said advertising network and that provides the user response to said advertising network.

28. The advertising system of claim 21, wherein said advertising analysis system compares the predicted effectiveness of each of the advertisement variations to identify a predetermined number of selected advertisement variations with highest predicted effectiveness and provides each of the predetermined number of selected advertisement variations as the effective advertisement.

29. The advertising system of claim 28, further comprising an advertiser system that selects the predetermined number of the selected advertisement variations to be provided as the effective advertisement.

30. The advertising system of claim 21, wherein said advertising analysis system updates the effective advertisement by repeatedly applying the multivariate testing to the plurality of advertisement variations, compiling the user response to each of the at least one test advertisement, performing the multivariate testing on the user response, and comparing the predicted effectiveness of each of the advertisement variations.

31. The advertising system of claim 30, wherein said advertising analysis system periodically updates the effective advertisement periodically to account for any changing conditions within the relevant advertising domain.
